(19) United States
(12) Patent Application Publication
(10) Pub. No.: US 2026/0097864 A1
(43) Pub. Date: Apr. 9, 2026

(54) INTERMITTENTLY PRESSURIZED LUNAR TERRAIN VEHICLE

(71) Applicant: Blue Origin Manufacturing, LLC, Huntsville, AL (US)

(72) Inventor: Michael L. Gernhardt, Houston, TX (US)

(21) Appl. No.: 18/911,088

(22) Filed: Oct. 9, 2024

(51) Int. Cl. B64G 1/46; B64G 1/16; B64G 6/00

(52) U.S. Cl. CPC B64G 1/46; B64G 1/16; B64G 6/00

(57) ABSTRACT

Systems and methods for operating a vehicle in an environment that requires an astronaut in the vehicle to wear a spacesuit, are presented. The vehicle may be a lunar rover or a rover to be used on Mars. An astronaut will be in a spacesuit while in the vacuum of the Moon. This vacuum or thin atmosphere will give rise to a pressure differential between the inside and the outside of the spacesuit. This pressure differential reduces the flexibility of the spacesuit, such that the joints of the spacesuit resist bending or flexing. Spacesuit stiffness is substantially reduced while an astronaut is in a pressurizable cabin of the vehicle, where the pressure differential can be reduced or eliminated. The spacesuit may provide all necessary life support while the cabin of the rover provides a cabin pressure that is substantially the same as the pressure in the spacesuit.

### BACKGROUND

A lunar roving vehicle (LRV) has been used during the last three Apollo missions. It was an electric vehicle designed to operate in the low-gravity vacuum environment of the Moon and to be capable of traversing the lunar surface, allowing the Apollo astronauts to extend the range of their surface extravehicular activities (EVAs). A renewed interest in planning missions to the Moon has led to a renewed interest in LRV designs. New designs may include many features of the Apollo rovers, such as a relatively simple frame carrying two or more seats, electric motors driving four wheels, a hand-operated controller/panel situated in front of the seats, steering control, and brakes.

The Apollo LRVs did not provide life support or protection from the lunar environment so the astronauts wore spacesuits while operating the LRVs. Spacesuits are inherently bulky and awkward to the wearer that may be tasked to perform activities requiring even a modest level of dexterity and motion precision. Such activities may include operating a rover or a manipulator (e.g., joystick) for a robotic sample-collecting arm, for example.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a schematic side view of a rover on a planetary or lunar surface, according to some embodiments.

FIG. 2 is a schematic representation of a portion of a space suit, illustrating interior and exterior pressures, according to some embodiments.

FIG. 3 is a sketch of an operator in a spacesuit in a rover, according to some embodiments.

FIG. 4 is a flow diagram of a process of operating a rover, exiting the rover for an EVA, and returning to the rover after the EVA, according to some embodiments.

### DETAILED DESCRIPTION

This disclosure describes, among other things, systems and methods for performing operations regarding a vehicle in an environment that requires an operator, or other persons, in the vehicle to wear a pressurized suit, such as a spacesuit. For example, the vehicle may be a lunar rover, such as those used in the Apollo 15-17 lunar missions, or a rover to be used on Mars. In other examples, the vehicle may be operated in relatively high-Earth altitudes or elevations where atmospheric pressure is low. Claimed subject matter is not limited to any particular locations for operating the systems or performing the methods described herein. In some embodiments, the vehicle may comprise equipment operated from within a pressurizable cabin of the vehicle. For example, such a vehicle may be excavating equipment, loading equipment, and so on. Hereinafter, any vehicle having a pressurizable cabin as described in the following embodiments and implementations will be called a rover.

Though a spacesuit is made up of many parts, embodiments described herein consider a spacesuit for one of its most general features, which is enclosing its wearer within a pressurized oxygen environment. Typically, the wearer, an astronaut, may be in a spacesuit while in the vacuum of space or the Moon, or the thin atmosphere of Mars. This vacuum or thin atmosphere will give rise to a pressure differential between the inside and the outside of the spacesuit. This pressure differential tends to reduce the flexibility of the spacesuit, rendering the joints of the spacesuit to be resistant to bending or flexing. For example, under a pressure differential, the spacesuit may present a resistance to bending at each finger joint, leading to reduced dexterity of the astronaut's hands. Joints in the legs and arms are similarly affected. During an extravehicular activity (EVA), a pressure differential leading to spacesuit stiffness may be unavoidable in many situations, but, as described for embodiments herein, spacesuit stiffness may be substantially reduced while an astronaut is in a cabin of a rover, where the pressure differential can be reduced or eliminated. For example, in a particular embodiment, a method for riding in or operating a rover includes attaching one end of an umbilical to a spacesuit worn by an occupant(s) (e.g., an astronaut) in a cabin of the rover and the other end of the umbilical to a part of the rover. The umbilical provides an exit from the spacesuit to vent CO2 and waste products from, respectively, an amine swing bed and an evaporator in the spacesuit, for example. The umbilical or other similar connection methods need not provide life support, such as oxygen, power, or communications, to the spacesuit from the rover. Instead, the spacesuit itself may provide all necessary life support. The method for riding in or operating the rover also includes pressurizing the cabin of the rover to a cabin pressure that is substantially the same as a pressure in the spacesuit worn by the occupant(s) in the cabin. Accordingly, a pressure differential across the “skin” of the spacesuit may be substantially reduced or eliminated and spacesuit stiffness will concomitantly be reduced, allowing for increased ease of astronaut motion while, for example, manipulating one or more controls of the rover. In some implementations, one or more controls that are manipulated to operate the rover may include a controller for a mechanical manipulator outside the cabin (e.g., operating a manipulator arm to pick up samples), a rover steering control, a rover speed control, or buttons on a control panel, just to name a few examples. Improvements in dexterity may also allow for operating cameras for far and near field viewing, as well as obtaining and/or assessing data from various scientific instruments. For example, some scientific instruments may require manipulation of buttons and other controls for downloading data from the instruments or adjusting various parameters of the instruments. Such activities could not easily be accomplished during an EVA, for example, with a delta pressure across the suit, such as a pressure delta of 4 or so pounds per square inch (PSI). In contrast, these activities would be simplified in the cabin of a rover sans a pressure differential.

In addition to improved dexterity and increased ease of general motion for an astronaut (e.g., the wearer) in a spacesuit, reducing a pressure differential between the inside and outside of the spacesuit may allow for reducing metabolic stress of the wearer. This would further allow for increasing potential mission durations, reducing astronaut fatigue, and improving astronaut performance. Further, a wider portion of a general population may be able to qualify for rover activities, making such activities accessible to additional populations beyond individuals meeting the rigorous fitness and training standards of modern astronauts.

Driving and performing various operations (e.g., operating a manipulator arm) within a pressurized cabin generally reduces the number of cycles placed on a spacesuit. For example, the reduced pressure differential across the spacesuit may reduce general wear and tear of the spacesuit by reducing stresses in the material of the spacesuit at or near the joints.

Yet another advantage of operating in a pressurized cabin of a rover may be a safety advantage. If an astronaut's spacesuit had a leak that is larger than the standard leak rate (which protects the astronaut for about 60 minutes, for example), the astronaut could return to the inside of the pressurized cabin where the leak would effectively stop (due to equalization of pressure inside and outside the spacesuit). Accordingly, the astronaut need not rely on a secondary oxygen system, thereby reducing demands on such a secondary oxygen system. This would provide the astronaut with enough time to safely drive back to the lander (or other base station) and ingress the airlock of the lander, for example.

In some implementations, the spacesuit includes an amine swing bed scrubber and an evaporator that provides cooling in the spacesuit. CO2 from the amine swing bed scrubber may be removed from the spacesuit via an umbilical that attaches to a port on the exterior of the spacesuit. Water or other coolant from the evaporator may also be removed from the spacesuit via the umbilical. Substances, such as CO2 and water, may be carried by the umbilical to an exit port of the rover or may be carried to respective storage tanks to be reused in some manner. In some implementations, all flows in the umbilical are from the spacesuit to the rover, and subsequently to one or more storage tanks and/or one or more exits to outside the rover (e.g., the vacuum of space).

In some embodiments, the cabin of the rover may be pressurized by a gas such as nitrogen, though another gas or a mixture of gases may also be used. The cabin may be depressurized by purging the cabin of the gas so that the cabin pressure is substantially the same as a pressure outside the cabin. This may be performed just before an EVA, for example. As described below, dust may be removed from the cabin by purging the gas through an exit to outside the cabin via a dust sump. In some implementations, the gas may be saved into a storage tank on the rover instead of purging the gas as a waste product to the vacuum of space. The saved gas may be recycled and used again (at least in part) to repressurized the cabin, such as after an EVA, for example. Conservation of gases may be beneficial in environments or conditions that do not have substantial supplies of such gases.

In some embodiments, a method for operating a rover during an EVA may include detaching a first end of an umbilical from a spacesuit worn by an astronaut in a cabin of the rover, where a second end of the umbilical remains attached to a part of the rover. The method continues with depressurizing the cabin from a cabin pressure that is substantially the same as a pressure in a spacesuit worn by the astronaut in the cabin to a cabin pressure that is substantially the same as a pressure outside the cabin, which is a vacuum on the Moon and a low atmospheric pressure on Mars, for example. The astronaut may then exit the rover to perform the EVA. As mentioned above, depressurizing the cabin may include purging a pressurizing gas in the cabin through a dust sump to outside the cabin. Also, or instead, depressurizing the cabin may include purging the pressurizing gas in the cabin to a storage tank on the rover.

After the EVA, the method may include the astronaut (and/or other persons) returning to the depressurized cabin, attaching the first end of the umbilical to the spacesuit, and re-pressurizing the cabin to the cabin pressure that is substantially the same as a pressure in the spacesuit. Oxygen supplied by the spacesuit may be provided to the astronaut. In other words, oxygen need not be supplied to the astronaut from the rover. In some implementations, the spacesuit includes an amine swing bed scrubber and an evaporator that provides cooling in the spacesuit. The umbilical may carry CO2 gas from the amine swing bed scrubber to a part of the rover, which may be an exit port to outside the rover or a storage tank, for example.

In some embodiments, a vehicle operable by an occupant wearing a pressurizable suit may comprise a cabin that is configured to pressurize to a cabin pressure that is substantially the same as a pressure in the pressurizable suit worn by the occupant in the cabin. For example, the pressure in the pressurizable suit may be greater than a pressure outside the cabin. For instance, the vehicle may be operated at relatively high elevations in a thin atmosphere (e.g., low atmospheric pressure). The pressurizable suit may be a type of spacesuit or any wearable garment capable of retaining a pressure differential between outside the suit and inside the suit, for example. The vehicle may also comprise a first end of an umbilical configured to attach to the pressurizable suit worn by the occupant in the cabin. A second end of the umbilical may be connected to a part of the vehicle. The vehicle may include one or more controls of the vehicle accessible to the occupant to operate the vehicle. The controls may include a controller for a mechanical manipulator outside the cabin, a vehicle steering control, and a vehicle speed control, just to name a few examples. In some implementations, oxygen may be provided to the occupant in the cabin by the pressurizable suit during the operating of the vehicle. In some implementations, a gas used to pressurize the cabin is purged through a dust sump to outside the cabin.

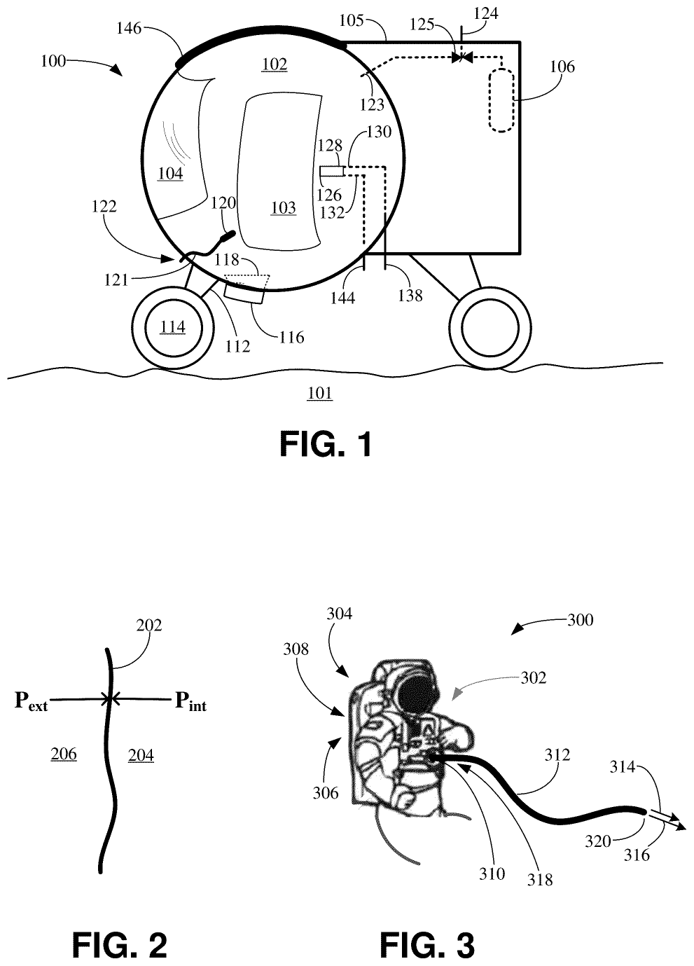

FIG. 1 is a schematic side view of a rover 100 on a planetary or lunar surface 101, according to some embodiments. For example, the rover may have some similarities to the lunar rovers used in the Apollo 15-17 lunar missions. Rover 100, which may be used on the Moon or on Mars, is a vehicle configured to operate in an environment that generally requires personnel (e.g., astronauts such as the driver and passenger(s)) in the vehicle to wear a pressurized suit, such as a spacesuit. Rover 100 includes a pressurizable cabin 102, which includes the space where the driver and passenger(s) ride and includes controls for driving the rover. The controls may also be for operating equipment or apparatuses attached to parts of rover 100 outside of cabin 102, such as controls for one or more robotic arms, excavating equipment, or loading equipment, just to name a few examples. In other words, such equipment or apparatuses may be operated from within pressurizable cabin 102 which, when pressurized to a pressure that is similar or equal to the pressure in a spacesuit (e.g., reduced or eliminated pressure differential), allows for improved dexterity for the astronaut. Cabin 102, which may be spherical, elliptical, or cylindrical to mechanically accommodate a pressure differential, also includes a door 103 for astronauts' ingress and egress and one or more windows 104.

Rover 100 may also include a non-pressurizable portion 105 that may be at least partially covered for controlling temperature or dust infiltration therein, for example. Portion 105 may include parts of the rover that need not be in the cabin, such as a tank 106 for storing gas used to pressurize the cabin. Functions of these tanks are described below. One or more motors, a chassis (a portion 112 of the chassis is illustrated), and wheels 114 attached thereto may also be included in non-pressurizable portion 105. It may be generally advantageous to include as few space-consuming things as possible in cabin 102 so that the pressurizable cabin can be relatively small, since the cabin, which can withstand a pressure differential, may likely be relatively heavy.

In some embodiments, cabin 102 of rover 100 may be pressurized by a gas such as nitrogen, though another gas or a mixture of gases may also be used. Alternatively, the cabin may be depressurized by purging the cabin of the gas so that the pressure in the cabin is substantially the same as the pressure outside the cabin. This may be performed just before an EVA, for example. In some implementations, gas may be purged through a dust sump 116, which is configured to collect dust through a screen 118 in the floor of the cabin. For example, dust on surface 101 of the Moon is abundant and potentially problematic for various operations to be performed on the Moon. Dust that sticks to the boots of astronauts as they enter the cabin, such as after an EVA for example, may shake off into dust sump 116. The size and form of dust sump 116 may be configured to maximize flow rate of gas that is purged therethrough from the cabin. Thus, this configuration may allow for the purged gas to carry the dust out of the dust sump and into the vacuum (or weak atmosphere) that is exterior to the cabin. In some implementations, a vacuum nozzle 120 may be attached to a flexible hose 121. During cabin depressurization, gas escaping from cabin 102 to the vacuum outside the cabin may at least partially flow into vacuum nozzle 120, which may then be used to suck out dust that has collected inside the cabin. The sucked out dust may then leave cabin 102 along with cabin gas at an exit port 122.

In some implementations, gas may be purged out of cabin 102 into a port 123 that leads to tank 106, which may store the purged gas. Optionally, gas exiting the cabin via port 123 may lead to an exit port 124, where the purged gas flows out of the rover, A valve 125 may be operated to select the destination of the purged gas. If tank 106 is the destination, then the purged gas may be reused at a later time to re-pressurize cabin 102. Pumps (not illustrated) may be used to transport the gas to/from tank 106 and may be used to achieve the desired cabin pressure. In some embodiments, tank 106 may be a supply tank to supply cabin-pressurizing gas, wherein pressurizing gas is not reused. In other words, in this case, tank 106 only supplies gas to the cabin and does not receive gas from the cabin.

In some embodiments, an astronaut, or other persons in cabin 102 of the rover, after driving to a destination, for example, may perform an EVA by depressurizing the cabin, as described above, from a cabin pressure that is substantially the same as a pressure in a spacesuit worn by the astronaut to a cabin pressure that is substantially the same as the pressure outside the cabin, which is a vacuum on the Moon and a low atmospheric pressure on Mars, for example. Before exiting the rover to perform the EVA, the astronaut may detach an end of an umbilical (not illustrated in FIG. 1) from the spacesuit worn by the astronaut. The other end of the umbilical remains attached to an attachment port 126 of the rover. Tubing 128, which may include one or more lines 130 and 132, terminates at the attachment port. As described below, lines 130 and 132 may correspond to lines in the umbilical. For example, line 130 may carry CO2 gas from an amine swing bed scrubber of the spacesuit to an exit port 138 that exhausts the CO2 gas into the vacuum of the Moon, for example. Line 132 may carry water to an exit port 144 that exhausts the water into the lunar vacuum (or the thin Martian atmosphere).

After the EVA, as described above, the astronaut (or additional astronauts) may return to the depressurized cabin, entering via door 103, reattach the end of the umbilical to the spacesuit, and pressurize the cabin to a cabin pressure that is substantially the same as the pressure in the spacesuit(s). Oxygen may be supplied to the astronaut by the spacesuit during the EVA and also during the astronaut's time in cabin 102, whether the cabin is pressurized or not. Accordingly, as already mentioned, oxygen need not be supplied to the astronaut by the rover.

In some implementations, radiation protection 146 may be placed on the “roof” of the rover for protection against a solar storm. For example, though a spacesuit worn by astronauts in rover 100 offers substantial protection from solar radiation, additional protection, such as four inches or water or polyethylene, built in to the rover may improve such protection.

FIG. 2 is a schematic representation of a portion 202 of a spacesuit “skin”, illustrating interior and exterior pressures, according to some embodiments. For example, inside 204 of the spacesuit may have an internal pressure Pᵢₙₜ to provide an atmosphere for an astronaut wearing the spacesuit. This pressure may be about 4 to 5 pounds per square inch (PSI). An external pressure Pₑₓₜ outside 206 of the spacesuit may be a vacuum, such as that at the lunar surface, or a thin atmosphere such as that on the Martian surface (about 0.1 PSI). A vacuum or thin atmosphere will give rise to a pressure differential, P_{diff}=Pᵢₙₜ−Pₑₓₜ between inside 204 and outside 206 of the spacesuit. As mentioned above, this pressure differential tends to reduce the flexibility of the spacesuit, leading to the joints of the spacesuit resisting bending or flexing. For example, during a lunar EVA, P_{diff} may be about 5 PSI, and the spacesuit may thus present a resistance to bending at the waste, elbows, knees, and so on. Moreover, each finger joint may be difficult to bend against such resistance, leading to reduced dexterity of the astronaut's hands. While a pressure differential leading to spacesuit stiffness may be unavoidable during an EVA, spacesuit stiffness may be substantially reduced while an astronaut is in cabin 102 of rover 100, for example, where the pressure differential can be reduced or eliminated by pressurizing the cabin to a Pₑₓₜ that is at least approximately the same as Pᵢₙₜ.

FIG. 3 is a sketch of an astronaut 300 in a spacesuit 302 in a rover, such as 100, according to some embodiments. On the back of the spacesuit is a backpack 304, which may hold oxygen to supply the astronaut. Backpack 304 may also include an amine swing bed scrubber 306 that removes carbon dioxide breathed out by the astronaut. The spacesuit may also include an evaporator 308 that provides cooling in the spacesuit. Among other things, spacesuit 302 may include an electrical supply (e.g., batteries), a fan to move oxygen throughout the spacesuit, a water tank to hold cooling water, a communications system, and so on.

In some implementations, spacesuit 302 includes an umbilical connection port 310 to connect or disconnect an umbilical 312 to/from the spacesuit. The umbilical may carry CO2, produced by amine swing bed scrubber 306, away from the spacesuit. The umbilical may also carry water, produced by evaporator 308, from the spacesuit. Umbilical 312 may include two lines (e.g., tubing). A first line 314 may carry CO2 and a second line 316 may carry water. A first end 318 of umbilical 312 connects to connection port 310 of spacesuit 302 and a second end 320, opposite the first end, of the umbilical may connect to a port in cabin 102 of the rover. Referring to FIG. 1, first line 314 in umbilical 312 corresponds to line 130, which carries CO2 gas and second line 316 in the umbilical corresponds to line 132, which carries water, for example. Accordingly, first line 314 connects to line 130 and second line 316 connects to line 132 when second end 320 of the umbilical connects to attachment port 126 of the rover.

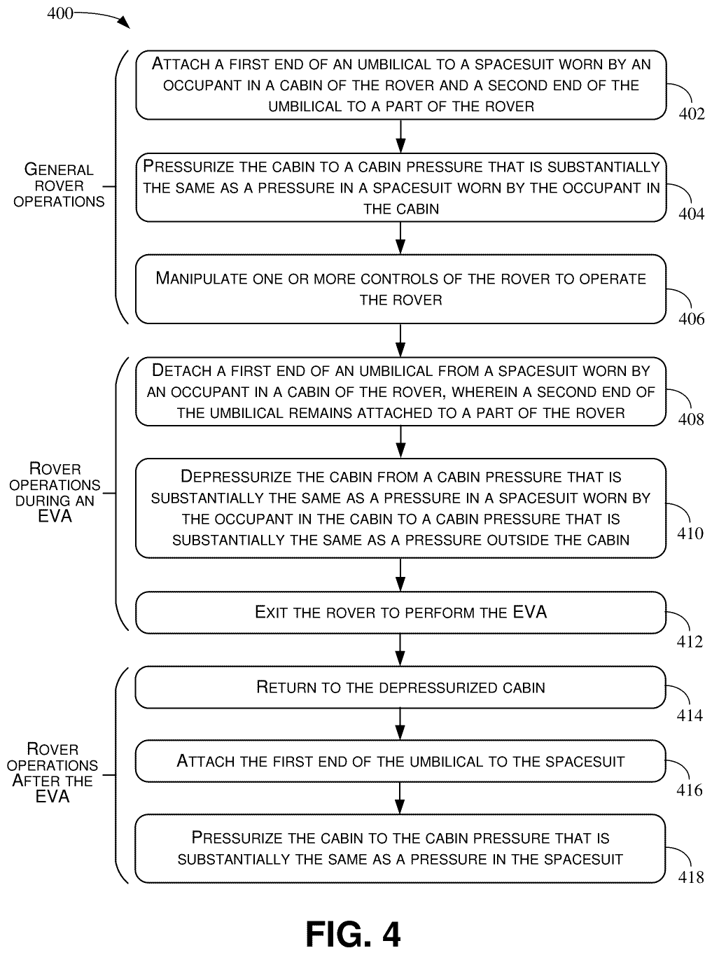

FIG. 4 is a flow diagram of a process 400 of operating a rover, which may involve exiting the rover for an EVA and returning to the rover after the EVA, according to some embodiments. For example, process 400 includes general rover operations, rover operations during an EVA, and rover operations after the EVA, steps of which are described below. The process may be performed by an astronaut 300 or other person(s) operating or riding in the rover in an environment that requires the astronaut or other person(s) to wear a spacesuit (e.g., 302). In some examples, the rover may be the same as or similar to rover 100, which includes pressurizable cabin 102.

At 402, the astronaut, wearing the spacesuit, enters the cabin of the rover at a cabin pressure of zero (e.g., vacuum). The astronaut may then attach first end 318 of umbilical 312 to port 310 on the spacesuit. Second end 320 of the umbilical may already be connected to a part of the rover, such as attachment port 126. If not, the astronaut may perform that task. First end 318 of umbilical 312 may be relatively close to a seat where the astronaut sits, for example. In some implementations, the astronaut need not connect the spacesuit to an umbilical. For example, some spacesuits are at least partially self-contained in that exhaust fluids like water and CO2 may be temporarily stored in the spacesuit or these fluids may be released directly from the spacesuit into the cabin (or outside environment during an EVA). In implementations described herein, the spacesuit is self-contained in that it provides oxygen and other life/mission supporting elements (e.g., cooling, heating, electrical power, communications, etc.) to the wearing astronaut. Accordingly, the astronaut needs not rely on the rover or umbilical to provide such elements.

At 404, the astronaut (or an automatic control system) may pressurize the cabin to a cabin pressure that is substantially the same as a pressure in spacesuit 302. Such a pressure may be about 4 or 5 PSI, though claimed subject matter is not so limited. In some implementations, the cabin may be pressurized with a gas, such as nitrogen, from tank 106.

Gas pumps in line 130 and the line attached to port 123 may be used to achieve desired cabin pressures. In some implementations, a mixture of CO2 and nitrogen, respectively from one tank or two, may be used to pressurize the cabin. For example, any gas, or gas mixture, that is, preferably, not flammable and won't chemically react with components in the cabin or the spacesuit may be used as a pressurizing gas.

At 406, while the cabin is pressurized to a pressure that is at least close to that of spacesuit 302, the astronaut may drive the rover, being able to more easily manipulate one or more controls of the rover because of the reduced or eliminated pressure differential inside and outside of the spacesuit. During such a reduced or eliminated pressure differential, the astronaut may also, or instead, be manipulating one or more controls to operate equipment that interacts with objects outside cabin 102. For example, buttons and a joystick may be manipulated by the astronaut through gloves of spacesuit 302 to operate a robotic arm.

In a subsequent part of process 400, the astronaut (and/or other accompanying persons) may embark on an EVA. In this situation, at 408, the astronaut may detach first end 318 of umbilical 312 from port 310 on the spacesuit. Second end 320 of the umbilical may remain connected to attachment port 126. At 410, the astronaut may depressurize the cabin from the cabin pressure that is substantially the same as the pressure in spacesuit 302 to a cabin pressure that is substantially the same as a pressure outside the cabin, which is likely vacuum or near vacuum. In other implementations, the astronaut may depressurize the cabin before detaching the umbilical from the spacesuit.

At 412, with no pressure differential between inside and outside of cabin 102, the astronaut may easily open door 103 and exit the cabin of the rover to perform the EVA. At this point, of course, there is a pressure differential between inside and outside of the spacesuit, and the astronaut will feel an increased stiffness and resistance of the suit, as compared to the feeling of the suit in the pressurized cabin.

After concluding EVA operations, at 414, the astronaut may return to the depressurized cabin. In some implementations, the astronaut may shake off or kick off dust that has collected on the astronaut's boots. For example, dust on the lunar surface is more than abundant and at least some measure of controlling the dust is often warranted. Dust falling from the boots of the spacesuit may collect into dust sump 116 through screen 118 in the floor of the cabin. As described above, a subsequent gas purge during a depressurization (e.g., 410) may carry the dust out of the dust sump and into the vacuum (or weak atmosphere) that is exterior to the cabin. In some implementations, as described above, vacuum nozzle 120 may be attached to flexible hose 121. During cabin depressurization, gas escaping from cabin 102 to the vacuum outside the cabin may at least partially flow into the vacuum nozzle, which may then be used to suck out dust that has collected inside the cabin.

At 416, the astronaut may attach first end 318 of umbilical 312 to port 310 on the spacesuit, as in 402. At 418, the astronaut (or the automatic control system) may re-pressurize the cabin to a cabin pressure that is substantially the same as a pressure in spacesuit 302.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

We claim as follows:

1. A method for operating a rover, the method comprising:
attaching a first end of an umbilical to a spacesuit worn by an occupant in a cabin of the rover and a second end of the umbilical to a part of the rover;
pressurizing the cabin to a cabin pressure that is substantially the same as a pressure in a spacesuit worn by the occupant in the cabin; and
manipulating one or more controls of the rover to operate the rover.

2. The method of claim 1, wherein oxygen provided to the occupant in the cabin is provided by the spacesuit during the operating of the rover.

3. The method of claim 1, wherein the spacesuit includes an amine swing bed scrubber and an evaporator that provides cooling in the spacesuit.

4. The method of claim 3, wherein the umbilical carries CO2 gas from the amine swing bed scrubber to the part of the rover.

5. The method of claim 3, wherein the umbilical carries water from the evaporator to the part of the rover.

6. The method of claim 1, further comprising purging the cabin of a gas used to pressurize the cabin to a cabin pressure that is substantially the same as a pressure outside the cabin.

7. The method of claim 6, wherein the gas is purged through a dust sump to outside the cabin.

8. The method of claim 6, wherein the gas is purged into a storage tank on the rover.

9. The method of claim 8, wherein the cabin is pressurized to the cabin pressure at least partially with the gas from the storage tank.

10. A vehicle operable by an occupant wearing a pressurizable suit, the vehicle comprising:
a cabin that is configured to pressurize to a cabin pressure that is substantially the same as a pressure in the pressurizable suit worn by the occupant in the cabin, wherein the pressure in the pressurizable suit is greater than a pressure outside the cabin;
a first end of an umbilical configured to attach to the pressurizable suit worn by the occupant in the cabin, wherein a second end of the umbilical is connected to a part of the vehicle; and
one or more controls of the vehicle accessible to the occupant to operate the vehicle.

11. The vehicle of claim 10, wherein oxygen provided to the occupant in the cabin is provided by the pressurizable suit during the operating of the vehicle.

12. The vehicle of claim 10, wherein a gas used to pressurize the cabin is purged through a dust sump to outside the cabin.

13. The vehicle of claim 10, wherein the one or more controls of the vehicle include a controller for a mechanical manipulator outside the cabin, a vehicle steering control, or a vehicle speed control.

14. A method for operating a rover during an extravehicular activity (EVA), the method comprising:
detaching a first end of an umbilical from a spacesuit worn by an occupant in a cabin of the rover, wherein a second end of the umbilical remains attached to a part of the rover;
depressurizing the cabin from a cabin pressure that is substantially the same as a pressure in a spacesuit worn by the occupant in the cabin to a cabin pressure that is substantially the same as a pressure outside the cabin; and
exiting the rover to perform the EVA.

15. The method of claim 14, wherein depressurizing the cabin comprises purging a pressurizing gas in the cabin through a dust sump to outside the cabin.

16. The method of claim 14, further comprising, after the EVA:
returning to the depressurized cabin;
attaching the first end of the umbilical to the spacesuit; and
pressurizing the cabin to the cabin pressure that is substantially the same as a pressure in the spacesuit.

17. The method of claim 16, wherein oxygen provided to the occupant wearing the spacesuit is provided by the spacesuit while the occupant operates the rover.

18. The method of claim 14, wherein the spacesuit includes an amine swing bed scrubber and an evaporator that provides cooling in the spacesuit.

19. The method of claim 18, wherein the umbilical carries CO2 gas from the amine swing bed scrubber to the part of the rover.

20. The method of claim 14, wherein all flows in the umbilical are from the spacesuit to the part of the rover.
